(19) United States
(12) Patent Application Publication
(10) Pub. No.: US 2024/0273886 A1
(43) Pub. Date: Aug. 15, 2024

(54) DATA ENHANCEMENT METHOD AND DEVICE

(71) Applicant: Lenovo (Beijing) Limited, Beijing (CN)

(72) Inventors: Yun XING, Beijing (CN); Yao MENG, Beijing (CN)

(21) Appl. No.: 18/695,242

(22) PCT Filed: Feb. 21, 2022
(86) PCT No.: PCT/CN2022/077042

§ 371 Date: Mar. 25, 2024

(30) Foreign Application Priority Data
Sep. 27, 2021 (CN) 202111135302.6

(51) Int. Cl. G06V 10/80; G06V 10/774; G06V 30/262

(52) U.S. Cl. CPC G06V 10/811; G06V 10/774; G06V 30/274

(57) ABSTRACT

A data enhancement method includes obtaining first data including sub-data of a plurality of modalities. The sub-data of one modality corresponds to one data type and the data types of different modalities are different. The method further includes determining, in the sub-data of each modality, an entity object matching the data type of the sub-data, and performing inference on the entity objects corresponding to different modalities based on entity relationship information in a knowledge graph to obtain second data different from the first data.

This application claims priority to Chinese Application No. 202111135302.6, filed with China patent office on Sep. 27, 2021 and titled “Data Enhancement Method and Device,” the entire content of which is incorporated herein by reference.

### TECHNICAL FIELD

The present disclosure generally relates to the field of software technologies and, more particularly, to a data enhancement method and device.

### BACKGROUND

In AI subtasks, data enhancement is always a common method to improve accuracy and solve data offset problems. Image rotation, translation, and other processing methods are often used in computer vision. Natural language processing is different from computer vision, and changing or deleting phrases in a sentence may affect the semantic coherence and correctness.

Information within different modalities in multimodal training data has certain limitations. Using only a single technology to process the information will waste the information supplement between different modalities.

### SUMMARY

The present disclosure provides a data enhancement method and device to alleviate the above problems. The technical solutions are described below.

One aspect of the present disclosure provides a data enhancement method. The method includes:
obtaining first data including sub-data of multiple modalities, where the sub-data of one modality corresponds to one data type and the data types of different modalities are different;
determining, in the sub-data of each modality, entity objects that match the data type of the sub-data; and
performing inference on the entity objects corresponding to different modalities based on entity relationship information in knowledge graph to obtain second data. The second data is different from the first data.

Optionally, the entity relationship information includes instance relationship information, and two entities in the instance relationship information are instances; and performing inference on the entity objects corresponding to different modalities based on the entity relationship information in the knowledge graph to obtain the second data includes:
determining target instance relationship information that matches the entity objects corresponding to different modalities in the instance relationship information, wherein two entity objects as instances in the target instance relationship information correspond to two modalities; and
obtaining the second data at least based on the target instance relationship information.

Optionally, the entity relationship information further includes concept relationship information, wherein two entities in the concept relationship information are concepts; and determining the target instance relationship matching the entity objects corresponding to different modalities in the instance relationship information includes:
determining concepts to which the entity objects corresponding to various modalities belong in the knowledge graph;
determining target concept relationship information that matches the entity objects corresponding to different modalities in the concept relationship information, wherein two entity objects corresponding to the concepts in the target concept relationship information correspond to the two modalities; and
determining new instance relationship information according to the target concept relationship information, wherein the two entity objects as instances in the new instance relationship information are two entity objects corresponding to the target concept relationship information and the relationship between instances in the new instance relationship information is the relationship between the concepts in the target concept relationship information.

Optionally, the entity relationship information further includes instance concept relationship information, wherein two entities in the concept relationship information are an instance and a concept respectively; and determining the target instance relationship matching the entity objects corresponding to different modalities in the instance relationship information includes:
determining concepts to which the entity objects corresponding to various modalities belong in the knowledge graph;
determining target instance concept relationship information that matches the entity objects corresponding to different modalities in the instance concept relationship information, wherein two entity objects corresponding to the concept and the instance in the target concept relationship information correspond to the two modalities;
determining new instance relationship information according to the target instance concept relationship information, wherein the two entity objects as instances in the new instance relationship information are two entity objects corresponding to the target instance concept relationship information.

Optionally, obtaining the second data at least based on the target instance relationship information includes:
obtaining common sense information matching the entity objects corresponding to different modalities; and
performing inference on the sub-data of different modalities using the target instance relationship information and the common sense information to obtain the second data.

Optionally, the entity relationship information includes concept information, and the concept information is used to represent description information of the concepts; and performing inference on the entity objects corresponding to different modalities based on the entity relationship information in the knowledge graph to obtain the second data includes:
determining concepts matching the entity objects corresponding to different modalities in the concept information;
determining target description information matching the entity objects corresponding to different modalities based on the concepts matching the entity objects corresponding to different modalities; and
performing inference on the sub-data of different modalities using the target description information to obtain the second data.

Optionally, performing inference on the sub-data of different modalities using the target description information to obtain the second data includes:
obtaining common sense information matching the entity objects corresponding to different modalities; and
performing inference on the sub-data of different modalities using the target description information and the common sense information to obtain the second data.

Optionally, the multiple modalities include a text modality and an image modality; and determining the entity objects matching the data type in the sub-data of each modality includes:
obtaining a first semantic model corresponding to the text modality;
inputting the sub-data of the text modality into the first semantic model, to obtain the text entities output by the first semantic model;
obtaining a second semantic model corresponding to the image modality; and
inputting the sub-data of the image modality into the second semantic model, to obtain image entities output by the second semantic model.

Optionally, the first semantic model also outputs first intention information corresponding to the text modality, and the second semantic model also outputs second intention information corresponding to the image modality; and determining the entity objects matching the data type in the sub-data of each modality includes:
obtaining target text entities from the text entities that match the first intention information; and
obtaining target image entities from the image entities that match the second intention information.

Another aspect of the present disclosure provides a data enhancement device, including: a data acquisition module, configured to obtain first data including sub-data of multiple modalities, where the sub-data of one modality corresponds to one data type and the data types of different modalities are different; an entity determination module, configured to determine, in the sub-data of each modality, entity objects that match the data type of the sub-data; and a data inference module, configured to perform inference on the entity objects corresponding to different modalities based on entity relationship information in knowledge graph to obtain second data, where the second data is different from the first data.

From the above technical solutions, it can be know that: in the data enhancement method provided by various embodiments of the present disclosure, for the sub-data of multiple modalities contained in the first data, the entity objects matching the data types of the sub-data may be determined, and then inference may be performed on the entity objects corresponding to different modalities based on the entity relationship information of the knowledge graph, to obtain the second data. The second data may be different from the first data. Therefore, the supplement of information between different modalities may be realized, enhancing the semantics of the data.

### BRIEF DESCRIPTION OF THE DRAWINGS

To explain the embodiments of the present disclosure or the technical solutions in the existing techniques more clearly, the drawings needed to be used in the description of the embodiments or the existing techniques will be briefly introduced below. Obviously, the drawings in the following description are only embodiments of the present disclosure. For those of ordinary skill in the art, other drawings may be obtained based on the provided drawings without creative efforts.

FIG. 1 is a hardware structural diagram of an electronic device consistent with the present disclosure.

FIG. 2 is a flowchart of a data enhancement method consistent with the present disclosure.

FIG. 3 is a schematic diagram showing sub-data of image modalities consistent with the present disclosure.

FIG. 4 is a flowchart of another data enhancement method consistent with the present disclosure.

FIG. 5 is a flowchart of a portion of a data enhancement method consistent with the present disclosure.

FIG. 6 is a flowchart of a portion of another data enhancement method consistent with the present disclosure.

FIG. 7 is a flowchart of another data enhancement method consistent with the present disclosure.

FIG. 8 is a flowchart of a portion of another data enhancement method consistent with the present disclosure.

FIG. 9 is a structural diagram showing a data enhancement device consistent with the present disclosure.

### DETAILED DESCRIPTION OF THE EMBODIMENTS

Specific embodiments of the present disclosure are hereinafter described with reference to the accompanying drawings. The described embodiments are merely examples of the present disclosure but not all embodiments of the present disclosure, and should not be regarded as limitations of this application. All other embodiments obtained by those of ordinary skill in the art without creative efforts fall within the scope of protection of the present disclosure.

To make the above objects, features and advantages of the present disclosure more obvious and understandable, the present disclosure will be described in further detail below in conjunction with the accompanying drawings and specific implementations.

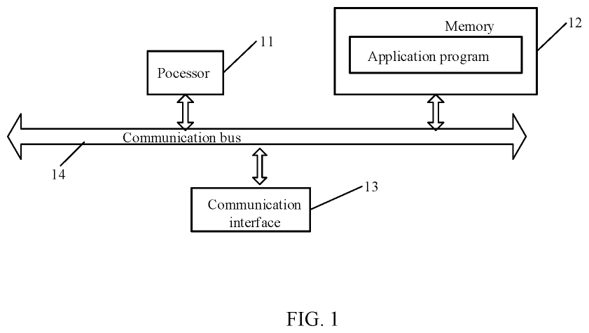

The present disclosure provides a data enhancement method. The method may be applied to an electronic device. FIG. 1 is a hardware structural diagram showing the electronic device. The hardware structure of the electronic device includes a processor 11, a communication interface 12, a memory 13, and a communication bus 14.

In some other embodiments, the electronic device may include at least one processor 11, at least one communication interface 12, at least one memory 13, and at least one communication bus 14. The at least one processor 11, the at least one communication interface 12, and the at least one memory 13 may communicate with each other through the at least one communication bus 14.

The processor 11 may be a central processing unit (CPU), a graphics processing unit (GPU) or graphics processor, an application-specific integrated circuit (ASIC), or one or more integrated circuits configured to implement the embodiments of the present disclosure.

The memory 13 may include a high-speed RAM, or may also include a non-volatile memory such as at least one disk memory.

The memory 13 may be configured to store an application program or the data generated by the operation of the application program.

The processor 11 may be configured to execute the application program to: obtain first data including sub-data of multiple modalities, where sub-data of one modality may correspond to one data type and data types of different modalities may be different; in the sub-data of each modality, determine entity objects matching the data type of the sub-data; and perform inference on the entity objects corresponding to different modalities according to entity relationship information in a knowledge graph, to obtain second data. The second data may be different from the first data.

It should be noted that the refinement and expansion of the functions implemented by the processor when executing the application program can be found in the description below.

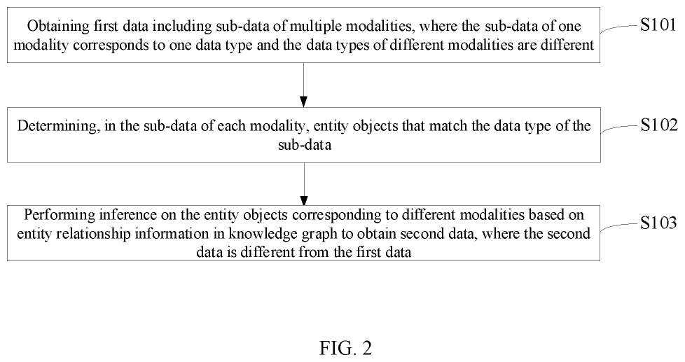

The present disclosure provides a data enhancement method. As shown in FIG. 2, which is a flowchart of a data enhancement method, in one embodiment, the method includes S101 to S103.

At S101, first data is obtained. The first data may include sub-data of multiple modalities. The sub-data of one modality may correspond to one data type, and the data types of different modalities may be different.

In one embodiment, the first data may include the sub-data of multiple modalities, and the sub-data of each modality may belong to one data type. The data types between any two modalities may be different. The data types of different modalities may include but are not limited to images, text, audio, or video.

Taking the two data types of images and text as an example, the first data may include the sub-data of the image modality (the sub-data includes images) and the sub-data of the text modality (the sub-data includes texts). The sub-data of the text modality may be used as a textual description of the sub-data of the image modality.

At S102, in the sub-data of each modality, entity objects matching the data type of the sub-data are determined.

In one embodiment, for the sub-data of each modality in the first data, an entity extraction method matching the data type of the sub-data may be used to determine the entity objects therein. Taking the data type of the image as an example, image recognition technology may be used to obtain image features in the sub-data of the image modality, and the image features may be used as the entity objects of the image modality, that is, the image entities. Take the data type of the text as another example, natural language processing technology may be used to obtain text features in the sub-data of the text modality, and the text features may be used as the entity objects of the text modality, that is, text entities.

For the audio data type, the sub-data of the audio modality may be converted into the sub-data of the text modality through speech recognition technology, and then the text features may be obtained through the natural language processing technology. The text features may be used as the entity objects of the audio modality. That is, an audio entity may be essentially a text entity. Similarly, for the data type of video, the sub-data of the video modality may be disassembled into the sub-data of the image modality. Same as the processing method of the sub-data of the image modality, the image features may be obtained through the image recognition technology (the image features may be a representation of a specific object or part), and the image features may be used as the entity objects of the video modality, that is, a video entity may be essentially an image entity.

In some embodiments, to achieve accurate entity extraction, the entity objects for text modality and image modality may be extracted through semantic models respectively. For the text modality, a first semantic model corresponding to the text modality may be obtained; the sub-data of the text modality may be input into the first semantic model, and the text entities output by the first semantic model may be obtained. For the image modality, a second semantic model corresponding to the image modality may be obtained, the sub-data of the image modality may be input into the second semantic model, and the image entities output by the second semantic model may be obtained.

In one embodiment, separate semantic models may be trained for the text modality and the image modality respectively. In another embodiment, a same semantic model may be trained for the text modality and the image modality through joint training, which is not limited in the present disclosure. Before training the semantic model, manual annotation of historical user input may be performed. For example, for the text modality, the sub-data of the text modality as historical user input may include at least one text entity. During manual annotation, each text entity may need to be accurately annotated. After completing the manual annotation, the semantic model may be trained with the sub-data of the text modality with (text entity) annotation. After the training, the semantic model may extract the text entities from the sub-data of the text modality subsequently input. Of course, the training process of semantic models for the image modality may be similar, which will not be described again here.

It should be noted that the semantic model corresponding to the text modality may use bidirectional encoder representation for transformers (BERT)+conditional random field (CRF), machine reading comprehension (MRC), etc., for entity extraction. The semantic model corresponding to the image modality may use solutions including ImageNET.

Based on above description, considering the different application scenarios of data enhancement, to ensure that the entity objects are adapted to the application scenarios, in one embodiment, the semantic model may further output intention information. For the text modality, the first semantic model may further output first intention information corresponding to the text modality. For the image modality, the second semantic model may further output second intention information corresponding to the image modality.

In one embodiment, before training the semantic model, the manual annotation of the historical user input may be performed. For example, for the text modality, the sub-data of text modality as the historical user input may include an intention. While manually annotating each text entity, it may be also necessary to annotate the intention information. Further, after completing the manual annotation, the semantic model may be trained with the sub-data of the text modality with (text entity and intention information) annotation. After the training, the semantic model may be able to extract the text entity and identify the intention information from the sub-data of the text modality subsequently input. Of course, in other embodiments, the intention information may be represented by classification labels.

It should be noted that, for the semantic model corresponding to the text modality, support vector machine (SVM), text convolutional neural network (TextCNN), long short-term memory network (LSTM), bidirectional encoder representation for transformers (BERT), etc., may be used for intention recognition.

Correspondingly, for the text modality, the entity objects that match the text modality may include a target text entity in the text entity that matches the first intention information. For the image modality, the entity objects that match the image modality may include a target image entity that matches the first intention information.

For example, for the image modality, assuming that the sub-data of the image modality input to the second semantic model is an image of a fruit section in a supermarket, the second semantic model may determine that the image entities contained in the sub-data may include “Apple,” “Banana,” “Grape,” “Watermelon,” etc. on shelves, and “Apple” in a pictorial. The intention information may be “supermarket-fruit.” Therefore, based on this intention information, “Apple” on the pictorial may be eliminated.

At S103, second data is obtained by performing inference on the entity objects corresponding to different modalities based on the entity relationship information in the knowledge graph. The second data is different from the first data.

In one embodiment, the knowledge graph may be a semantic network structure under a specified application scenario. Nodes of the knowledge graph may represent entities and edges may represent relationships between the entities. A triplet composed of “node-edge-node” may be “entity-relation- entity.” The entities may include instances, such as person names, place names, organization names, or other collections with specific attributes. For example, the text entities contained in the text “I love Beijing Tiananmen” include two instances of “Beijing” and “Tiananmen.” The entities may also include concepts, such as a collection of instances with certain characteristics such as countries, nations, cities, etc. For example, the image entities contained in a landscape image include two concepts of “tree” and “house.” Therefore, the entity relationship information in the knowledge graph may be the triplet information composed of node-edge-node, such as “Tiananmen—located in—Beijing.”

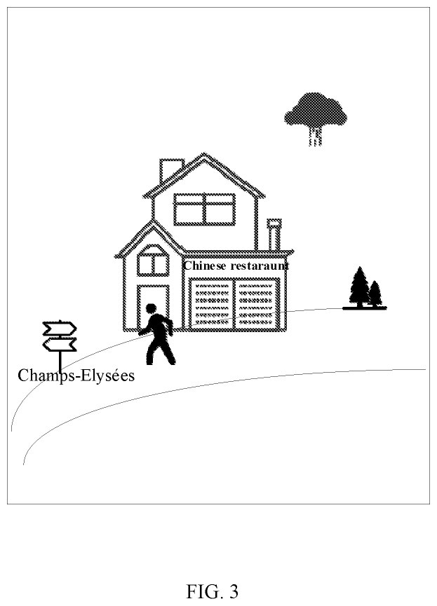

For better understanding, the first data including the sub-data of the text modality and the sub-data of the image modality is used as an example. For example, in one embodiment, the sub-data of the text modality includes “a man walking on the street of Paris in the rain” and the sub-data of the image modality is shown in FIG. 3. After S102, the text entities corresponding to the text modality may be determined to include “man,” “Paris” and “street.” In the sub-data of the image modality, person, road signs marked with street names (later described with “Champs-Elysees” as an example) and buildings marked with “La Rose Chinese Restaurant” may be identified in the image modality. The image entities corresponding to the image modality may be determined to include “person,” “Champs-Elysees,” and “La Rose Chinese Restaurant.”

Correspondingly, the entity relationship between the text entities corresponding to the text modality and the image entities corresponding to the image modality may be obtained by inference based on the existing entity relationship information in the knowledge graph, and the sub-data of the text modality or the sub-data of the image modality in the first data may be supplemented according to the inferred entity relationship, to obtain new data, that is, the second data. The second data may be the text modality or the image modality. For example, the knowledge graph may already include the entity relationship information “Champs-Elysées—located in—Paris.” Based on this, the relationship between the text entity “Paris” and the image entity “Champs-Elysees” may be determined. Therefore, the second data of the text modality, such as “a man walks on Champs-Elysees in Paris in the rain,” may be obtained.

In the data enhancement method in the embodiments of the present disclosure, complementary information between multiple modalities may be captured by combining the knowledge graph and entity extraction, thereby generating the enhanced data and improving the overall accuracy and diversity of downstream tasks.

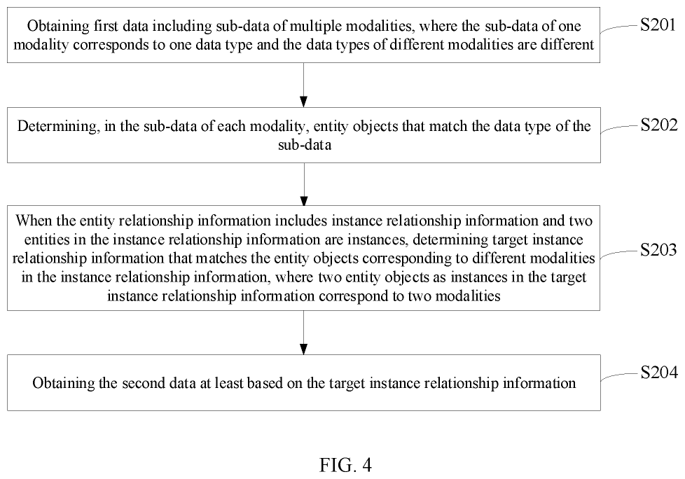

Another embodiment of the present disclosure also provides another data enhancement method. As shown in FIG. 4, which is a flowchart of the data enhancement method, the method includes S201 to S204.

At S201, first data is obtained. The first data may include sub-data of multiple modalities. The sub-data of one modality may correspond to one data type, and the data types of different modalities may be different.

At S202, in the sub-data of each modality, entity objects matching the data type of the sub-data are determined.

At S203, when the entity relationship information includes instance relationship information, and two entities in the instance relationship information are instances, target instance relationship information matching the entity objects corresponding to different modalities in the instance relationship information is determined, and two entity objects as instances in the target instance relationship information correspond to two modalities.

In one embodiment, the entity relationship information in the knowledge graph may include the instance relationship information, that is, “instance—relationship—instance.” Therefore, for the entity objects corresponding to various modalities in the first data, the entity objects belonging to instances may be first determined, and then the instance relationships of the entity objects (belonging to instances) between different modalities, that is, the target instance relationship information, may be determined. Two entity objects as the instances in the instance relationship information may belong to two modalities.

For the convenience of understanding, the first data including the sub-data of the text modality and the sub-data of the image modality will be used as an example for description. For example, the text entities belonging to the instances in the sub-data of the text modality “a man walking on the street of Paris in the rain” include “man” and “Paris” (hereinafter referred to as the text instances for the convenience of description), and the image entities belonging to the instances corresponding to the image modality include “Champs-Elysées” and “La Rose Chinese Restaurant” (hereinafter referred to as the image instances for convenience of description).

By matching text instances and image instances, the instance relationship information containing one text instance and one image instance, that is, the target instance relationship information, may be determined from the knowledge graph, and may include “text instance—relationship—image instance” or “image instance—relationship—text instance.”

At S204, the second data is obtained at least based on the target instance relationship information. The second data may be different from the first data.

In one embodiment, for the convenience of understanding, the first data including the sub-data of the text modality and the sub-data of the image modality will be used as an example for description. Assuming that the target instance relationship information in the knowledge graph is determined to include two instance relationship information of “Champs-Elysées—located in—Paris” and “La Rose Chinese Restaurant—located in—Paris” by matching the text instances and the image instances, the second data of the text modality such as “a man walking on the Champs-Elysées in Paris in the rain” may be obtained by replacing “street” with “Champs-Elysées,” and the second data of the text modality such as “La Rose Chinese restaurant is located in Champs-Elysées in Paris” may be also obtained based on the two instance relationship information.

In the data enhancement method in the embodiments of the present disclosure, complementary information between multiple modalities may be captured according to the instance relationship information in the knowledge graph, thereby generating the enhanced data related to the instances and improving the overall accuracy and diversity of downstream tasks.

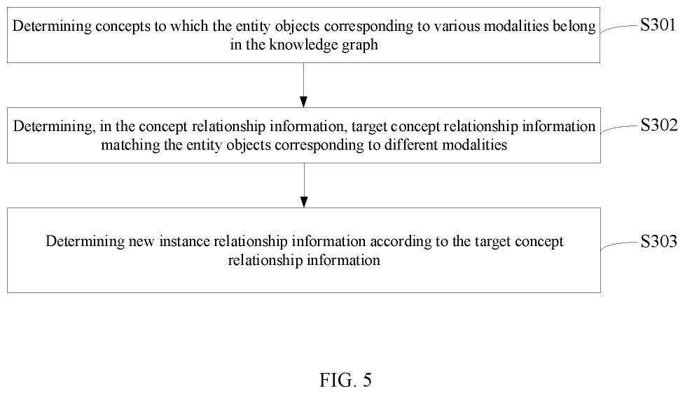

In another embodiment, the entity relationship information may also include concept relationship information, and both entities in the concept relationship information may be concepts. As shown in FIG. 5, which is a partial flowchart of the data enhancement method, in the present embodiment, determining the target instance relationship information matching the entity objects corresponding to different modalities in the instance relationship information at S203 includes S301 to S303.

At S301, concepts to which the entity objects corresponding to various modalities belong in the knowledge graph are determined.

In one embodiment, for the convenience of understanding, the first data including the sub-data of the text modality and the sub-data of the image modality will be used as an example for description. The text instances in the sub-data of the text modality “A man walking on the streets of Paris in the rain” include “man” and “Paris,” and the image instances corresponding to the image modality include “Champs-Elysees” and “La Rose Chinese Restaurant.”

Through the concept information in the knowledge graph, the concept to which each text instance or each image instance belongs may be obtained. For example, the concept to which the text instance “man” belongs is “person,” the concept to which the text instance “Paris” belongs is “city,” the concept to which the image instance “Champs-Elysees” belongs is “street,” and the concept to which the image instance “La Rose Chinese Restaurant” belongs is “restaurant.”

At S302, target concept relationship information matching the entity objects corresponding to different modalities is determined in the concept relationship information. Two entity objects in the target concept relationship information corresponding to concepts may correspond to two modalities.

In one embodiment, in addition to instance relationship information, the entity relationship information in the knowledge graph may also include the concept relationship information, that is, “concept—relationship—concept.” Therefore, for the entity objects corresponding to various modalities in the first data, after determining the concepts to which the entity objects belong, the relationship between concepts between different modalities, that is, the target concept relationship information, may be further determined. Two concepts in the target concept information may be entity objects belonging to two modalities.

For the convenience of understanding, the first data including the sub-data of the text modality and the sub-data of the image modality will be used as an example for description. By matching the concepts to which the text instances belong and the concepts to which the image instances belong, the concept relationship information including the concept to which a certain text instance belongs and the concept to which an image instance belongs, that is, the target concept relationship information, may be determined from the knowledge graph, which may be “the concept to which the text instance belongs—relationship—the concept to which the image instance belongs” or “the concept to which the image instance belongs—relationship—the concept to which the text instance belongs.”

At S303, new instance relationship information is determined according to the target concept relationship information. Two entity objects as instances in the new instance relationship information may be two entity objects corresponding to the target concept relationship information, and the relationship between instances in the new instance relationship information may be the relationship between concepts in the target concept relationship information.

For the convenience of understanding, the first data including the sub-data of the text modality and the sub-data of the image modality will be used as an example for description. The concept to which the text instance “man” belongs is “person,” the concept to which the text instance “Paris” belongs is “city,” the concept to which the image instance “Champs-Elysées” belongs is “street,” and the concept to which the image instance “La Rose Chinese Restaurant” belongs is “restaurant.”

Assuming that the target concept relationship information determined at S302 includes “street—affiliated to—city” and “restaurant—located in—city,” the instance relationship information “Champs-Elysées—affiliated to—Paris” may be determined according to the concept relationship information “street—affiliated to—city” and the instance relationship information “La Rose Chinese Restaurant—located in—Paris” may be determined based on the concept relationship information “restaurant—located in—city.” Therefore, “Champs-Elysées—affiliated to—Paris” and “La Rose Chinese Restaurant—located in—Paris” may be determined as the new instance relationship information inferred based on the concept relationship information in the knowledge graph. The new instance relationship information may be added to the knowledge graph to supplement and improve the knowledge graph.

In the data enhancement method provided by the present disclosure, the new instance relationship information may be inferred according to the existed concept relationship information in the knowledge graph, to continuously supplement and improve the knowledge graph. With the integration of more business knowledge, the instance relationship inferring results may become more reasonable, and the method may have good practicability and effectiveness.

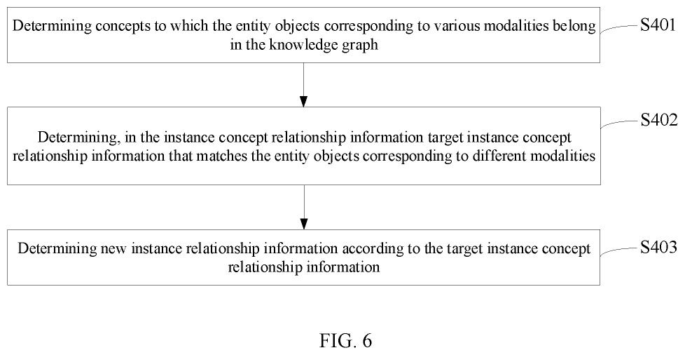

In another embodiment, the entity relationship information may also include instance concept relationship information, and two entities in the concept relationship information may be a concept and an instance respectively. As shown in FIG. 6 which is a partial flowchart of the data enhancement method, in the present embodiment, determining the target instance relationship information matching the entity objects corresponding to different modalities in the instance relationship information at S203 includes S401 to S403.

At S401, concepts to which the entity objects corresponding to various modalities belong in the knowledge graph are determined.

In one embodiment, for the first data including the sub-data of the text modality and the sub-data of the image modality which is used as an example for description, the text entities in the sub-data of the text modality “a man walking on the street of Paris in the rain” include “man,” “Paris,” and “street,” and the text instances include “man” and “Paris.” Corresponding to the image modality, the image entities include “person,” “Champs-Elysées” and “La Rose Chinese Restaurant,” and the image instances include “Champs-Elysées” and “La Rose Chinese Restaurant.”

Through the concept information in the knowledge graph, the concepts to which each text instance or each image instance belongs may be obtained. For example, the concept to which the text instance “man” belongs is “person,” the concept to which the text instance “Paris” belongs is “city,” the concept to which the image instance “Champs-Elysées” belongs is “street,” and the concept to which the image instance “La Rose Chinese Restaurant” belongs is “restaurant.” Of course, the text entity “street” may be determined as a concept (which is called a text concept hereinafter), and the image entity “person” may be determined as a concept (which is called an image concept hereinafter).

At S402, target instance concept relationship information matching the entity objects corresponding to different modalities is determined in the instance concept relationship information. Two entity objects in the target instance concept relationship information corresponding to the instance and the concept may correspond to two modalities.

In one embodiment, in addition to instance relationship information, the entity relationship information in the knowledge graph may also include the instance concept relationship information, that is, “instance—relationship—concept.” Therefore, for the entity objects corresponding to various modalities in the first data, after determining the concepts to which the entity objects belong, the relationship between the instances and concepts between different modalities, that is, the target instance concept relationship information, may be further determined. Two entity objects as the instance and the concept in the target concept information may belong to two modalities.

In one embodiment, for the first data including the sub-data of the text modality and the sub-data of the image modality which is used as an example for description, by matching the concepts to which the text instances belong and the concepts to which the image instances belong, the instance concept relationship information including a certain text instance and the concept to which an image instance belongs, or including an image instance and the concept to which a text instance belongs, that is, the target instance concept relationship information, may be determined from the knowledge graph, which may be “the text instance—relationship—the concept to which the image instance belongs” or “the image instance—relationship—the concept to which the text instance belongs.”

At S403, new instance relationship information is determined according to the target instance concept relationship information. Two entity objects as instances in the new instance relationship information may be two entity objects corresponding to the target instance concept relationship information.

In one embodiment, for the first data including the sub-data of the text modality and the sub-data of the image modality which is used as an example for description, by matching the text instance and the image concept, or the image instance and the text concept, the target instance concept relationship information may be determined to include “man—belong to—person” and “Champs-Elysées—belong to—street.” The knowledge graph may already include the concept entity relationship information, that is, the entity relationship information “concept—relationship—instance,” such as “person—walking—Champs-Elysées” or “street—located in—Paris.” The concept and the entity in the determined concept entity relationship information may belong to the same modal.

Therefore, according to “man—belong to—person” and “person—walk—Champs-Elysées,” the image instance “Champs-Elysées” may be used as the entity object corresponding to the image concept “person.” By combining the relationship “walking” in “person—walking—Champs-Elysées,” the new instance relationship information “man—walking—Champs-Elysées” may be obtained. Similarly, according to “Champs-Elysees—belongs to—Street” and “street—located in—Paris,” the text instance “Paris” may be used as the entity object corresponding to the text concept “street,” and by combining the relationship “located in” in “street—located in—Paris,” the new instance relationship information “Champs-Elysées—located in—Paris” may be obtained.

In the data enhancement method provided by the present disclosure, the new instance relationship information may be inferred according to the existed instance concept relationship information in the knowledge graph, to continuously supplement and improve the knowledge graph. With the integration of more business knowledge, the instance relationship inferring results may become more reasonable, and the method may have good practicability and effectiveness.

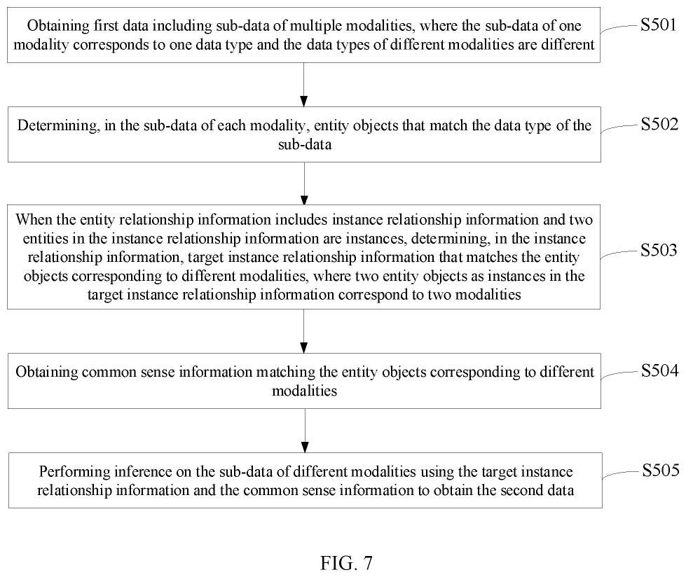

Another embodiment of the present disclosure provides another data enhancement method. As shown in FIG. 7, which is a flowchart of the data enhancement method in the present embodiment, the method includes S501 to S505.

At S501, first data is obtained. The first data may include sub-data of multiple modalities. The sub-data of one modality may correspond to one data type, and the data types of different modalities may be different.

At S502, in the sub-data of each modality, entity objects matching the data type of the sub-data are determined.

At S503, when the entity relationship information includes instance relationship information and two entities in the instance relationship information are instances, target instance relationship information matching the entity objects corresponding to different modalities in the instance relationship information is determined, and two entity objects as instances in the target instance relationship information correspond to two modalities.

At S504, common sense information that matches the entity objects corresponding to different modalities is obtained.

In one embodiment, target instance relationship information may be combined with the common sense information to obtain semantically smooth and coherent enhanced data. For example, for the first data including the sub-data of the text modality and the sub-data of the image modality, the text entities may include “man,” “Paris” and “street,” and the image entities may include “person,” “Champs-Elysées,” and “La Rose Chinese Restaurant.” By matching the text entities and the image entities in the common sense information of the knowledge graph, the common sense information that matches the text entities and the common sense information that matches the image entities may be obtained. For example, the matched common sense information may include “the city is composed of many streets,” “person walks on the street,” or “a restaurant is a building on the street,” etc.

At S504, inference is performed on the sub-data of different modalities using the target instance relationship information and the common sense information, to obtain the second data. The second data may be different from the first data.

In one embodiment, for the first data including the sub-data of the text modality and the sub-data of the image modality which is used as an example for description, assuming that the target instance relationship information in the knowledge graph is determined to include two instance relationship information of “Champs-Elysées—located in—Paris” and “La Rose Chinese Restaurant—located in—Paris,” “a man walking on Champs-Elysées in the rain” may be obtained according to the common sense information of “the city is composed of many streets” and “a person walks on the street.” Or, “there is a La Rose Chinese restaurant on the street in Paris” or “La Rose Chinese restaurant is located in Champs-Elysées in Paris” may be also obtained based on the common sense information of “a restaurant is a building on the street.” Or “a man walks around La Rose Chinese restaurant in Champs-Elysées” or “a man just passed by La Rose Chinese restaurant” may be obtained by combining the sub-data of the text modality.

In the data enhancement method in the embodiments of the present disclosure, the semantically smooth and coherent enhanced data may be obtained by combining the instance relationship information and the common sense information in the knowledge graph, thereby improving the overall accuracy and diversity of downstream tasks.

In one embodiment, the entity relationship information may include concept information, and the concept information may represent description information of the concepts. As shown in FIG. 8, correspondingly, S103 where the second data is obtained by inferring the entity objects corresponding to different modalities based on the entity relationship information in the knowledge graph, includes S601 to S603.

At S601, concepts matching the entity objects corresponding to different modalities are determined in the concept information.

In one embodiment, the concept information in the knowledge graph may be able to describe the concepts in the knowledge graph as instances. For example, for the first data including the sub-data of the text modality and the sub-data of the image modality which is used as an example, the text instances include “man” and “Paris,” the text concepts include “street,” the image instances include “Champs-Elysées” and “La Rose Chinese Restaurant,” and the image concepts may include “person.” The concept to which the text instance “man” belongs is “person,” the concept to which the text instance “Paris” belongs is “city,” the concept to which the image instance “Champs-Elysées” belongs is “street,” and the concept to which the image instance “La Rose Chinese Restaurant” belongs is “restaurant.”

At S602, according to the concepts matching the entity objects corresponding to different modalities, target description information matching the entity objects corresponding to different modalities is determined.

In one embodiment, for the first data including the sub-data of the text modality and the sub-data of the image modality which is used as an example for description, the concepts matching the entity objects corresponding to the text modality may include “person,” “city” and “street,” and the concepts matching the entity objects corresponding to the image modality may include “person,” “street” and “restaurant.” Therefore, by matching the concepts in the concept information in the knowledge graph, the description information describing one or more concepts in “person,” “city,” “street” and “restaurant,” that is, the target description information, may be obtained.

At S603, inference is performed on the sub-data of different modalities using the target description information, to obtain the second data.

For example, for the first data including the sub-data of the text modality and the sub-data of the image modality which is used as an example, assuming that the target description information corresponding to “city” is obtained as “the rainy season of the French city-Paris is concentrated in winter, and the rainy season of the Chinese city-Beijing is concentrated in summer,” the associated target description information “the rainy season in French city - Paris is concentrated in winter” may be obtained by combining the text instance “Paris.” By combining the sub-data of the text modality “a man walking on the streets of Paris in the rain,” the second data of the text modality “a man walking on the streets of Paris in winter” or “a man walking in the rain in Paris in winter”, etc. may be obtained.

In some other embodiments, while ensuring the coherence and correctness of the enhanced data semantics, when inferring the second data, the common sense information matching the entity objects corresponding to different modalities may also be obtained, and further, inference may be performed on the sub-data of different modalities using the target description information and the common sense information, to obtain the second data.

In one embodiment, for the first data including the sub-data of the text modality and the sub-data of the image modality which is used as an example for description, the text entities may include “man,” “Paris” and “street,” and the image entities may include “person,” “Champs-Elysées,” and “La Rose Chinese Restaurant.” By matching the text entities and the image entities in the common sense information of the knowledge graph, the common sense information that matches the text entities and the common sense information that matches the image entities may be obtained. For example, the matched common sense information may include “the city is composed of many streets,” “person walks on the street,” or “a restaurant is a building on the street,” etc.

Further, the target description information corresponding to “city” may be obtained as “the rainy season of the French city-Paris is concentrated in winter, and the rainy season of the Chinese city-Beijing is concentrated in summer.” The associated target description information “the rainy season in French city—Paris is concentrated in winter” may be obtained by combining the text instance “Paris.” Therefore, according to the sub-data of the text modality and the sub-data of the image modality, “a man walking on the streets of Paris in winter” may be obtained by combining the common sense information “the city is composed of many streets” and “person walks on the street,” and “a man walking on Champs-Elysées in winter, and there is a La Rose Chinese restaurant on Champs-Elysées” may be obtained by combining the common sense information “a restaurant is a building on the street.”

In the data enhancement method in the embodiments of the present disclosure, the semantically smooth and coherent enhanced data may be obtained by combining the concept information and the common sense information in the knowledge graph, thereby improving the overall accuracy and diversity of downstream tasks.

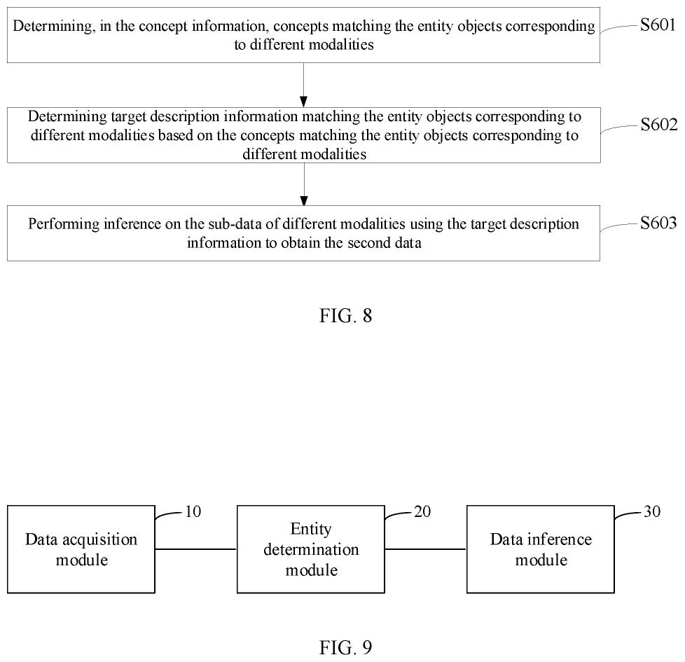

The present disclosure also provides a data enhancement device corresponding to the data enhancement method provided by previous embodiments. As shown in FIG. 9, in one embodiment, the data enhancement device includes:
a data acquisition module 10, configured to obtain first data including sub-data of multiple modalities, where the sub-data of one modality may correspond to one data type and the data types of different modalities may be different;
an entity determination module 20, configured to: in the sub-data of each modality, determine entity objects matching the data type of the sub-data; and
a data inference module 30, configured to perform inference on the entity objects corresponding to different modalities based on the entity relationship information in the knowledge graph, to obtain second data, where the second data is different from the first data.

In one embodiment, in the data enhancement device, the entity relationship information may include instance relationship information, and two entities in the instance relationship information may be instances. When configured to perform inference on the entity objects corresponding to different modalities based on the entity relationship information in the knowledge graph to obtain the second data, the data inference module 30 may be configured to:
determine target instance relationship information matching the entity objects corresponding to different modalities in the instance relationship information, where two entity objects as instances in the target instance relationship information correspond to two modalities; and obtain the second data at least based on the target instance relationship information.

In one embodiment, in the data enhancement device, the entity relationship information may further include concept relationship information, and two entities in the concept relationship information may be concepts. When configured to perform inference on the entity objects corresponding to different modalities based on the entity relationship information in the knowledge graph to obtain the second data, the data inference module 30 may be configured to:
determine concepts to which the entity objects corresponding to various modalities belong in the knowledge graph; determine target concept relationship information matching the entity objects corresponding to different modalities in the concept relationship information, where two entity objects in the target concept relationship information corresponding to concepts may correspond to two modalities; and determine new instance relationship information according to the target concept relationship information. Two entity objects as instances in the new instance relationship information may be two entity objects corresponding to the target concept relationship information, and relationship between instances in the new instance relationship information may be relationship between concepts in the target concept relationship information.

In one embodiment, in the data enhancement device, the entity relationship information may further include instance concept relationship information, and two entities in the concept relationship information may be a concept and an instance respectively. When configured to perform inference on the entity objects corresponding to different modalities based on the entity relationship information in the knowledge graph to obtain the second data, the data inference module 30 may be configured to:
determine concepts to which the entity objects corresponding to various modalities belong in the knowledge graph; determine target instance concept relationship information matching the entity objects corresponding to different modalities in the instance concept relationship information, where two entity objects in the target instance concept relationship information corresponding to the concept and the instance may correspond to two modalities; and determine new instance relationship information according to the target instance concept relationship information. Two entity objects as instances in the new instance relationship information may be two entity objects corresponding to the target instance concept relationship information.

In one embodiment, in the data enhancement device, when being configured to obtain the second data at least based on the target instance relationship information, the data inference module 30 may be configured to:
obtain common sense information that matches the entity objects corresponding to different modalities; and perform inference on the sub-data of different modalities using the target instance relationship information and the common sense information, to obtain the second data.

In one embodiment, in the data enhancement device, the entity relationship information may further include concept information for characterizing description information of concepts. When configured to perform inference on the entity objects corresponding to different modalities based on the entity relationship information in the knowledge graph to obtain the second data, the data inference module 30 may be configured to:
determine concepts matching the entity objects corresponding to different modalities in the concept information; according to the concepts matching the entity objects corresponding to different modalities, determine target description information matching the entity objects corresponding to different modalities; and perform inference on the sub-data of different modalities using the target description information, to obtain the second data.

In one embodiment, when being configured to perform inference on the sub-data of different modalities using the target description information, to obtain the second data, the data inference module 30 may be configured to:
obtain common sense information matching the entity objects corresponding to different modalities; and perform inference on the sub-data of different modalities using the target description relationship information and common sense information, to obtain the second data.

In one embodiment, in the data enhancement device, the multiple modalities may include a text modality and an image modality. When being configured to determine, in the sub-data of each modality, the entity objects matching the data type of the sub-data, the entity determination module 20 may be configured to:
obtain a first semantic model corresponding to the text modality; input the sub-data of the text modality into the first semantic model to obtain the text entities output by the first semantic model; obtain a second semantic model corresponding to the image modality; and input the sub-data of the image modality into the second semantic model; and obtain the image entities output by the second semantic model.

In one embodiment, in the data enhancement device, the first semantic model may also output first intention information corresponding to the text modality, and the second semantic model may also output second intention information corresponding to the image modality.

When being configured to determine, in the sub-data of each modality, the entity objects matching the data type of the sub-data, the entity determination module 20 may be configured to:
obtain target text entities in the text entities that match the first intention information; and obtain target image entities in the image entities that match the second intention information.

The present disclosure describes various embodiments of the data enhancement method and the data enhancement device, and these embodiments are only used to help understand the present disclosure. Those skilled in the art may modify the implementation and the application range. Therefore, the present disclosure should not be understood as the limitation.

Each embodiment in this specification is described in a progressive mode, and each embodiment focuses on the difference from other embodiments. Same and similar parts of each embodiment may be referred to each other. As for the device disclosed in the embodiments, since it corresponds to the method disclosed in the embodiments, the description is relatively simple, and for relevant details, the reference may be made to the description of the method embodiments.

It should also be noted that in the present disclosure, relational terms such as “first” and “second” are only used to distinguish one entity or operation from another entity or operation, and do not necessarily require or imply that there is such actual relationship or sequence between these entities or operations them. Furthermore, the terms “comprises,” “includes,” or any other variation thereof are intended to cover a non-exclusive inclusion, such that an article or device including a list of elements includes not only those elements, but also other elements not expressly listed. Or it also includes elements inherent to the article or equipment. Without further limitation, an element defined by the statement “comprises a . . . ” does not exclude the presence of other identical elements in a process, method, article or device that includes the above-mentioned element.

Various embodiments have been described to illustrate the operation principles and exemplary implementations. It should be understood by those skilled in the art that the present disclosure is not limited to the specific embodiments described herein and that various other obvious changes, rearrangements, and substitutions will occur to those skilled in the art without departing from the scope of the present disclosure. Thus, while the present disclosure has been described in detail with reference to the above described embodiments, the present disclosure is not limited to the above described embodiments, but may be embodied in other equivalent forms without departing from the scope of the present disclosure.

1. A data enhancement method comprising:
obtaining first data including sub-data of a plurality of modalities, the sub-data of one modality corresponding to one data type and the data types of different modalities being different;
determining, in the sub-data of each modality, an entity object matching the data type of the sub-data; and
performing inference on the entity objects corresponding to different modalities based on entity relationship information in a knowledge graph to obtain second data, the second data being different from the first data.

2. The method according to claim 1, wherein:
the entity relationship information includes instance relationship information, and two entities in the instance relationship information being instances; and
performing inference on the entity objects corresponding to different modalities based on the entity relationship information in the knowledge graph to obtain the second data includes:
determining target instance relationship information that matches the entity objects corresponding to different modalities in the instance relationship information, the two entity objects as the instances in the target instance relationship information correspond to two modalities; and
obtaining the second data at least based on the target instance relationship information.

3. The method according to claim 2, wherein:
the entity relationship information further includes concept relationship information, two entities in the concept relationship information being concepts; and
determining the target instance relationship matching the entity objects corresponding to different modalities in the instance relationship information includes:
determining concepts to which the entity objects corresponding to various modalities belong in the knowledge graph;
determining target concept relationship information that matches the entity objects corresponding to different modalities in the concept relationship information, two entity objects corresponding to the concepts in the target concept relationship information corresponding to the two modalities; and
determining new instance relationship information according to the target concept relationship information, the two entity objects as instances in the new instance relationship information being two entity objects corresponding to the target concept relationship information and a relationship between instances in the new instance relationship information being a relationship between the concepts in the target concept relationship information.

4. The method according to claim 2, wherein:
the entity relationship information further includes instance concept relationship information, two entities in the concept relationship information being an instance and a concept respectively; and
determining the target instance relationship matching the entity objects corresponding to different modalities in the instance relationship information includes:
determining concepts to which the entity objects corresponding to various modalities belong in the knowledge graph;
determining target instance concept relationship information that matches the entity objects corresponding to different modalities in the instance concept relationship information, two entity objects corresponding to the concept and the instance in the target concept relationship information corresponding to the two modalities; and
determining new instance relationship information according to the target instance concept relationship information, the two entity objects as instances in the new instance relationship information being two entity objects corresponding to the target instance concept relationship information.

5. The method according to claim 2, wherein obtaining the second data at least based on the target instance relationship information includes:
obtaining common sense information matching the entity objects corresponding to different modalities;
performing inference on the sub-data of different modalities using the target instance relationship information and the common sense information to obtain the second data.

6. The method according to claim 1, wherein:
the entity relationship information includes concept information, and the concept information is used to represent description information of concepts; and
performing inference on the entity objects corresponding to different modalities based on the entity relationship information in the knowledge graph to obtain the second data includes:
determining concepts matching the entity objects corresponding to different modalities in the concept information;
determining target description information matching the entity objects corresponding to different modalities based on the concepts matching the entity objects corresponding to different modalities; and
performing inference on the sub-data of different modalities using the target description information to obtain the second data.

7. The method according to claim 6, wherein performing inference on the sub-data of different modalities using the target description information to obtain the second data includes:
obtaining common sense information matching the entity objects corresponding to different modalities; and
performing inference on the sub-data of different modalities using the target description information and the common sense information to obtain the second data.

8. The method according to claim 1, wherein:
the plurality of modalities include a text modality and an image modality; and
determining, in the sub-data of each modality, the entity object matching the data type of the sub-data includes:
obtaining a first semantic model corresponding to the text modality;
inputting the sub-data of the text modality into the first semantic model, to obtain a text entity output by the first semantic model;
obtaining a second semantic model corresponding to the image modality; and
inputting the sub-data of the image modality into the second semantic model, to obtain an image entity output by the second semantic model.

9. The method according to claim 8, wherein:
the first semantic model also outputs first intention information corresponding to the text modality, and the second semantic model also outputs second intention information corresponding to the image modality; and
determining, in the sub-data of each modality, the entity object matching the data type of the sub-data includes:
obtaining, from the text entity, a target text entity that matches the first intention information; and
obtaining, from the image entity, a target image entity that matches the second intention information.

10. (canceled)

11. An electronic device comprising:
at least one processor; and
at least one memory storing at least one application program that, when executed by the at least one processor, causes the at least one processor to:
obtain first data including sub-data of a plurality of modalities, the sub-data of one modality corresponding to one data type and the data types of different modalities being different;
determine, in the sub-data of each modality, an entity object matching the data type of the sub-data; and
perform inference on the entity objects corresponding to different modalities based on entity relationship information in a knowledge graph to obtain second data, the second data being different from the first data.

12. The electronic device according to claim 11, wherein:
the entity relationship information includes instance relationship information, and two entities in the instance relationship information being instances; and
the at least one application program, when executed by the at least one processor, further causes the at least one processor to:
determine target instance relationship information that matches the entity objects corresponding to different modalities in the instance relationship information, the two entity objects as the instances in the target instance relationship information correspond to two modalities; and
obtain the second data at least based on the target instance relationship information.

13. The electronic device according to claim 12, wherein:
the entity relationship information further includes concept relationship information, two entities in the concept relationship information being concepts; and
the at least one application program, when executed by the at least one processor, further causes the at least one processor to:
determine concepts to which the entity objects corresponding to various modalities belong in the knowledge graph;
determine target concept relationship information that matches the entity objects corresponding to different modalities in the concept relationship information, two entity objects corresponding to the concepts in the target concept relationship information corresponding to the two modalities; and
determine new instance relationship information according to the target concept relationship information, the two entity objects as instances in the new instance relationship information being two entity objects corresponding to the target concept relationship information and a relationship between instances in the new instance relationship information being a relationship between the concepts in the target concept relationship information.

14. The electronic device according to claim 12, wherein:
the entity relationship information further includes instance concept relationship information, two entities in the concept relationship information being an instance and a concept respectively; and
the at least one application program, when executed by the at least one processor, further causes the at least one processor to:
determine concepts to which the entity objects corresponding to various modalities belong in the knowledge graph;
determine target instance concept relationship information that matches the entity objects corresponding to different modalities in the instance concept relationship information, two entity objects corresponding to the concept and the instance in the target concept relationship information corresponding to the two modalities; and
determine new instance relationship information according to the target instance concept relationship information, the two entity objects as instances in the new instance relationship information being two entity objects corresponding to the target instance concept relationship information.

15. The electronic device according to claim 12, wherein the at least one application program, when executed by the at least one processor, further causes the at least one processor to:
obtain common sense information matching the entity objects corresponding to different modalities;
perform inference on the sub-data of different modalities using the target instance relationship information and the common sense information to obtain the second data.

16. The electronic device according to claim 11, wherein:
the entity relationship information includes concept information, and the concept information is used to represent description information of concepts; and
the at least one application program, when executed by the at least one processor, further causes the at least one processor to:
determine concepts matching the entity objects corresponding to different modalities in the concept information;
determine target description information matching the entity objects corresponding to different modalities based on the concepts matching the entity objects corresponding to different modalities; and
perform inference on the sub-data of different modalities using the target description information to obtain the second data.

17. The electronic device according to claim 16, wherein the at least one application program, when executed by the at least one processor, further causes the at least one processor to:
obtain common sense information matching the entity objects corresponding to different modalities; and
perform inference on the sub-data of different modalities using the target description information and the common sense information to obtain the second data.

18. The electronic device according to claim 11, wherein:
the plurality of modalities include a text modality and an image modality; and
the at least one application program, when executed by the at least one processor, further causes the at least one processor to:
obtain a first semantic model corresponding to the text modality;
input the sub-data of the text modality into the first semantic model, to obtain a text entity output by the first semantic model;
obtain a second semantic model corresponding to the image modality; and
input the sub-data of the image modality into the second semantic model, to obtain an image entity output by the second semantic model.

19. The electronic device according to claim 18, wherein:
the first semantic model also outputs first intention information corresponding to the text modality, and the second semantic model also outputs second intention information corresponding to the image modality; and
the at least one application program, when executed by the at least one processor, further causes the at least one processor to:
obtain, from the text entity, a target text entity that matches the first intention information; and
obtain, from the image entity, a target image entity that matches the second intention information.
